(19) United States
(12) Patent Application Publication
(10) Pub. No.: US 2011/0264246 A1
(43) Pub. Date: Oct. 27, 2011

(54) CELLULAR PHONE SOFTWARE APPLICATION TO PROMOTE SAFETY AND SELECTIVELY DETER UNSAFE PHONE USE

(75) Inventors: TINA PANTOJA, Houston, TX (US); William Scott Taylor, Houston, TX (US)

(73) Assignee: W2W LLC

(21) Appl. No.: 13/091,977

(22) Filed: Apr. 21, 2011

Related U.S. Application Data
(60) Provisional application No. 61/327,282, filed on Apr. 23, 2010.

(51) Int. Cl. G06F 19/00

(52) U.S. Cl. 700/92

(57) ABSTRACT

A method and apparatus for providing a user of a mobile device, such as a cell phone, with applicable legal or safety information, such as restrictions on the use of a cell phone, potential fines for cell phone use, potential dangers, personal protective equipment requirements, prohibitions, guidelines and the like, based on GPS position of the mobile device. A gaming aspect is incorporated as a method of incentivizing drivers to utilize the application by providing reward points uses the cell phone in a safe manner and consistent with applicable laws. Accrued points may be redeemed for gift cards or similar rewards.

### CROSS REFERENCE TO RELATED APPLICATION

This application is based upon provisional application 61/327,282 filed on Apr. 23, 2010, which is incorporated herein by reference and the priority of which is claimed.

### BACKGROUND OF THE INVENTION

1. Field of the Invention

This invention relates generally to preventing danger and consequences that arise from the use of cellular phones, and in particular, their text messaging capabilities, while the users are operating a motor vehicle.

2. Background Art

Recent media reports highlight the rise in catastrophic accidents that are caused by distraction and reduced reaction time due to consumer texting while driving. The percentage of young drivers texting or using other hand-held electronic devices has increased from 2007, according to the National Highway Traffic Safety Administration's 2008 nationwide survey. According to the survey, at any given moment during daylight hours, approximately 812,000 vehicles are being driven by someone using a hand-held cell phone, and in 16 percent of all fatal traffic fatalities, driver distraction was a factor.

In response to this ever growing danger, many states and municipalities have passed laws to prohibit or limit the use of cell phones while driving in designated areas, such as schools, creating a patchwork approach to safeguarding students and other pedestrians at critical times and places in various communities.

For example, a number of states have outlawed handheld cell phone use while driving, or have banned cell phone use for certain types of drivers. Most make an exception for emergency calls to police, the fire department, medical personnel, and the like.

At least five states, California, Connecticut, New Jersey, New York, and Washington, have enacted laws banning the use of handheld cell phones while driving. With the exception of Washington, these states allow “primary enforcement of an offense.” That means that police officers can pull one over for using a handheld cell phone without any other reason for the traffic stop.

Seventeen states and the District of Columbia have enacted special cell phone driving laws for novice drivers, for example, those with a learner's permit, or young drivers, such as those under the age of 18. For example, in California, drivers under the age of 18 cannot use any type of communication device while driving. States with these types of restrictions include: California, Colorado, Connecticut, Delaware, Illinois, Maine, Maryland, Minnesota, Nebraska, New Jersey, North Carolina, Oregon, Rhode Island, Tennessee, Texas, Virginia, Washington D.C., and West Virginia.

Fifteen states plus the District of Columbia have also banned school bus drivers from using cell phones while passengers are present.

Two states, Washington and New Jersey, have banned text messaging for all drivers. Some states, including Utah and New Hampshire, lump cell phone use into a larger ban on distracted driving. For example, in Utah, speaking on a cell phone may be a violation if the driver has committed another moving offense.

In addition to state-wide prohibitions, many towns and cities have banned certain types of cell phone use while driving. Finally, the prohibitions of cell phone use while driving is not limited to the United States. The list of foreign countries that have some sort of cell phone ban for drivers is significant. Most of these countries ban handheld cell phones, not hands-free devices.

Some cell phone applications exist that attempt to address cell-phone related distractions while driving. For example, iZUP is a mobile cell phone application developed by Illume Software that holds text messages, emails, and telephone calls and prevents web browsing and running other non-navigation-related cell phone applications while the cell phone is in a moving vehicle. Another software application, Zoomsafer for example, disables the display and keyboard of a smart phone when it is moving at greater than 15 miles per hour unless it is in a hands-free enabled node, via Bluetooth for example. Other applications, such as iLANE, convert incoming text and email messages to voice.

These present applications attempt to curb unsafe user behavior by negative reinforcement—prohibiting certain smart phone functionality under given conditions. Rebellious teenagers may be tempted, however, to circumvent cell phone restriction applications mandated by parents. None of the known applications employ positive reinforcement techniques, such as used in online gaming and which has found to be particularly effective in teenagers and young adults. It is desirable, therefore, to provide a cell phone application that motivates the user to avoid unsafe practices by rewarding the user for good behavior.

Additionally, given the ever-changing patchwork of municipal ordinances and state laws that address cell phone usage, it is difficult for a user to know what legal consequences might result from his or her actions. None of the present applications notify the user of the particular ordinances, regulations, or laws that are in effect in a particular location at a particular time It is desirable to inform the user of the legal consequences for using a cell phone in a particular area, and with positive reinforcements for safe behavior, allowing the user to exercise his or her sound discretion in determining whether or not to use a cell phone in a particular situation.

3. Identification of Objects of the Invention

A primary object of the invention is to provide a method and apparatus that effectively deters unsafe practices of phone use while driving.

Another object of the invention is to provide a method and apparatus that utilizes a reward program to encourage safe cell phone practice and adherence to laws.

Another object of the invention is to provide a method and apparatus for deterring unsafe cell phone practices that is cost effective.

Another object of the invention is to provide a method and apparatus that automatically informs the user of local laws and policies when the user enters neighborhoods, cities, counties, or states where cell phone usage prohibitions have been enacted, thus alerting the user of the potential legal consequences of driving while using a mobile communications device.

Another object of the invention is to provide a method and apparatus that automatically informs the user of potential hazards or specific requirements when the user enters defined areas such as confined spaces, refineries, manufacturing plants, ships, facilities, and military installations, thus alerting the user of the potential dangerous consequences while working or entering into these areas.

Another object of the invention is to provide a method and apparatus including a web-based application to tract a user's position, monitor safe driving, and inform the user when entering defined areas that have specific safety requirements.

### SUMMARY OF THE INVENTION

The objects described above and other advantages and features of the invention are incorporated in a method and apparatus that provides positive, behavior-modifying reinforcement for deterring unsafe behaviors, including unsafe cell phone use, and in particular, text messaging (“texting”), while driving. In addition, other safety-related information, such as personal protective equipment requirements, prohibitions, or other pre-defined guidelines, may be provided to the user based on the user's location.

In a preferred embodiment, the invention is embodied in at least one SafeCell software application in combination with a hand held device, cell phone, smart phone (such as an iPhone®, Android® device or personal GPS unit), personal digital assistant (“PDA”) (such as a Palm Pilot® or Blackberry® device), or tablet computer (such as the Motorola Galaxy®, or iPad® devices) hereinafter simply referred to as a mobile device, and a computer server that communicates with the end-user SafeCell software application(s).

Most modern mobile devices include an onboard Global Positioning System (“GPS”) receiver, which can provide position, velocity, altitude, and directional information. The SafeCell application receives and processes input from the mobile devices' GPS receiver and uses the GPS position and velocity information to log details about a user's trips. For mobile devices that include an accelerometer, accelerometer input may also be received and processed by the SafeCell application.

The SafeCell application accesses a database containing all legal safety equipment, standards, processes, prohibitions or other guidelines that are searchable in terms of the locality in which the prohibition applies. The SafeCell application, based on mobile devices location as determined by GPS, displays the applicable legal and safety information, if any, for their location. For example, the SafeCell application determines if the user's mobile device is within a known school zone, and if so, the application provides a notification indicating that the user is entering a “No Cell Phone Zone” and displays the corresponding icon and or potential fine(s). Similarly, if the user's mobile device is located within a known hazardous area, the application provides a notification indicating that the user is entering such an area and displays the required safety equipment, standards, processes, prohibitions and other pre-defined guidelines.

When the SafeCell application is enabled (either manually prior to beginning the user's trip or automatically), any time vehicle is moving more than 4 miles per hour, the application disables text message, email, and telephone call functionality, responding to incoming communications with an automated message to let those others know that the user is temporarily unavailable because in transit. The SafeCell application logs text messages, email, and calls that were missed when disabled due to transit. Once the SafeCell application has determined that motion has ceased, text messaging, email, and telephone functions are automatically re-enabled. In this “in transit” restricted-use mode, the SafeCell application includes an emergency override capability for 911 and up to three other emergency contact numbers, such as parents, employer, etc. A passenger-use override capability may also be included.

According to a default operation setting, the restricted “in transit” mode, which restricts text message, email, and telephone call functionality when traveling at speed, may be suspended at any time by the mobile device user. However, the ability to suspend the restricted “in transit” mode may be limited due to parental settings, if desired. The SafeCell application logs when and where its restricted “in transit” mode is suspended, the particular cell phone usage that occurs during these periods, such as whether text messaging or voice telephone calls are made, what speeds and accelerations occurred during the period, and what legal restrictions were in place at the time. These parameters are logged to a web based account hosted on a SafeCell server computer, which can be accessed and reviewed by parents and employers, for example. Such web based account may include a customized landing page for the users, if desired.

Based on the cell phone usage patterns developed during a user's trips, for example, whether or not text messaging is used while the phone is in motion or whether the mobile device is used in a “no cell phone” school zone, the system and method according to the preferred embodiment includes a web-based rewards and tracking system, in which points are accumulated by the user for rewarding safe behaviors. Likewise, points may be deducted from a user's point balance for unsafe mobile device usage (such as suspending the SafeCell application in order to receive or place a call). The reward points may be redeemed by the user in a variety of ways, such as in gift cards, vouchers, and the like. Reward points may also be used to promote gaming play between multiple subscribers to the SafeCell application, in which users can compete against one another to win prizes.

As part of the web based interface provided to users is the capability to have multiple “cell phone numbers” added to a primary account. An individual, manager, business, or parent will have the ability to monitor the usage of the mobile device(s) under their account. As part of primary accounts settings is the ability to predefine the time and/or locations that a mobile device has the ability to send text messages. The account holder can also set predefined geographical areas that the mobile device should be located. When the monitored mobile device exits the allowed area, a predefined message is systemically sent to the primary account holder's designated contact address notifying them.

The SafeCell application preferably has the ability to display real-time traffic and or weather relevant to a journey based on way points and user's position. The trip way points may be captured and stored from a previous trip or manually entered or downloaded. An application programming interface displays the traffic or weather information.

### BRIEF DESCRIPTION OF THE DRAWINGS

The invention is described in detail hereinafter on the basis of the embodiments represented in the accompanying figures, in which:

FIG. 1 is a block diagram illustrating interaction and information exchange between a SafeCell application server computer system and an end user mobile device running a SafeCell application;

FIG. 2A is a high-level logic flow schematic according to a preferred embodiment of the invention, showing four distinct branches of logic account logic, trip logic, cell phone rule logic, and game theory logic that are provided to a SafeCell application user based on information supplied by the user;

FIG. 2B is a block diagram illustrating a domain or data model for implementing the logic of FIG. 2A according to a preferred embodiment of the invention;

FIG. 3 is a block level flow chart outlining a preferred implementation of the trip logic branch of FIG. 2 wherein the movements of an end user mobile device running a SafeCell application are tracked;

FIG. 4 is a view of a mobile device client tracking screen, showing an orb icon that provides information about cell phone restrictions;

FIG. 5 is a view of a mobile device client navigation and trip screen, showing a map that provides information about cell phone restrictions as well as navigation assistance that allows a user to plan, name and save completed trips;

FIG. 6 is a view of a mobile device client emergency number screen, showing three preprogrammed emergency numbers that may be rapidly accessed with one-button control;

FIG. 7 is a view of a mobile device client game toggle screen, showing a button that allows the user to enable or disable game play features of the SafeCell application;

FIG. 8A is a view of a mobile device client screen, showing information for most recent trips, including status icons indicating adherence or lack of adherence to applicable cell phone laws and gaming points that were rewarded or deducted for those trips;

FIG. 8B is an alternative view of recent trip screen of FIG. 5B in which the adherence icons and gaming points indicia are combined;

FIG. 9 is a view of a mobile device client trip history screen in which missed calls or interruptions are logged for the most recent trip;

FIG. 10 is a view of a mobile device client user's home screen, showing a summary of points accrued for the three most recent trips and the user's cumulative gaming score;

FIG. 11 is a view of a mobile device client leader board screen, showing the leading members of a user's peer group of SafeCell application subscribers based on cumulative gaming score;

FIG. 12 a view of a mobile device client download rules screen, showing various cell phone rules that have been downloaded by the user;

FIG. 13 a view of a mobile device client signup screen, showing data fields to be initially populated by a subscriber;

FIG. 14 is a view of a mobile device client device management screen, showing multiple mobile device clients that are associated with a single family account;

FIG. 15 is a view of a mobile device client password screen, showing fields for entry of a password to access parental or employer controls and settings; and

FIG. 16 is a view of a mobile device client options screen, showing various icons for accessing various functions available within the SafeCell software application.

### DESCRIPTION OF THE PREFERRED EMBODIMENT OF THE INVENTION

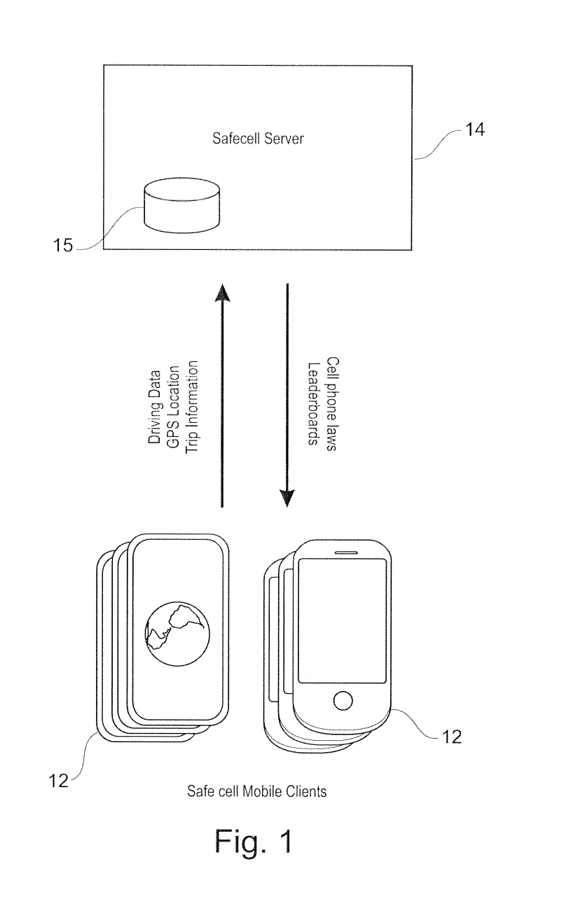

FIG. 1 illustrates a preferred embodiment of the invention, including a central server computer 14 in communication with a SafeCell software application residing in and executed by a cell phone, smart phone (such as an iPhone® or Android® device), or personal digital assistant (“PDA”) (such as a Palm Pilot® or Blackberry® device), or tablet computer (such as the Motorola Galaxy®, or iPad® devices) hereinafter simply referred to as a mobile device client 12. Preferably, numerous mobile device clients 12 (each running a SafeCell application) are in combination with the central server computer 14.

The SafeCell application is preferably downloadable and installable on mobile devices directly from server computer 14 or another business web site. The SafeCell application includes step by step instructions for installation and setup, including preferences, and parental controls, for example.

The SafeCell software application is preferably developed for use in iPhone SDK environment using Apple's Cocoa development platform or other mobile devices software development applications. The iPhone and iPad touch are sophisticated devices that combine the revolutionary multi-touch interface with powerful features, such as email and instant-messaging capability, and a full-featured browser. Additionally, the SafeCell software application is preferably adapted for use with all other smart phones, cell phones, and PDAs having sufficient capability. The SafeCell software application ideally includes the ability to be integrated into each applicable mobile device's operating system (“OS”) to allow for the application to be launched automatically at the startup of the device and run in background. Alternatively, if the SafeCell software application is not running in background, one-touch activation of the application is provided.

Server computer 14 receives and collect data from mobile device client 12, including trip details (location, velocity, heading, altitude, starts and stops) and mobile device usage details. Server computer 14 manages family and enterprise account settings, including the calculation of reward points. Finally, server computer 14 includes one or more of databases 15, from which it provides information to the end users regarding the relevant laws, ordinances, prohibitions, legal, safety equipment, standards, processes, prohibitions and other forms of pre-defined guidelines (hereinafter simply “cell phone usage rules or guidelines”) for the user based on the location of the mobile device client 12.

Mobile device client 12 preferably employs cellular data connections (including GPRS, EDGE, 3G, 4G) and includes an onboard Global Positioning System (“GPS”) receiver, which can provide position velocity, heading, altitude, starts, and stops information. Assisted GPS, which utilizes cell-tower-triangulation, Wi-Fi hotspot visibility, etc., to supplement GPS, privately owned GP systems maintained by companies may also be used. The SafeCell application receives and processes input from the mobile device's GPS receiver and uses the GPS position, location, velocity, heading, altitude, starts, and stops information to log details about a user's trips. For mobile device's that include an accelerometer, accelerometer input may also be received and processed by the SafeCell application.

Mobile device client 12 provides includes a SafeCell software application. Upon launch of the application, the system immediately checks to identify whether the phone is in use with a Bluetooth-enabled device. As some of the cell phone restriction rules accommodate cell phone usage with Bluetooth or other appropriate hands-free enabling devices, the SafeCell application takes the mobile devices present configuration into consideration. If the mobile device client is not presently connected to an appropriate hands-free device but an applicable law allows cell phone use with such device, the SafeCell application notifies the user so that he or she may enable hand-free devices, if available.

In addition to hands-free use via Bluetooth, the SafeCell mobile device client may provide for hands-free voice control of the various SafeCell application functions, for example, via the Ford Motor Company SYNC AppLink interface, General Motors OnStar® interface, Garmin® interface, TeleCommunication Systems VS Navigatora® as well as other onboard navigation user interfaces. The SYNC AppLink as other listed interfaces allows hands-free voice control or steering wheel button control of popular iPhone®, Android®, or BlackBerry® Smartphone applications. The SafeCell application is preferably voice activated by the user using various commands, such as “Start SafeCell” for launching the SafeCell application. The SafeCell application can also be launched automatically on other devices once the vehicle is in motion at 4 miles per hour. Other commands are also ideally provided. Voice control also preferably includes the use of software-generated audible voice prompts triggered by geographical position. For example, the user may be notified with a voice prompt, “You are now entering a no cell school zone,” “Cell phones are now allowed,” “Personal Protection Level V is not required,” or “Caustic Area—No Entry.”

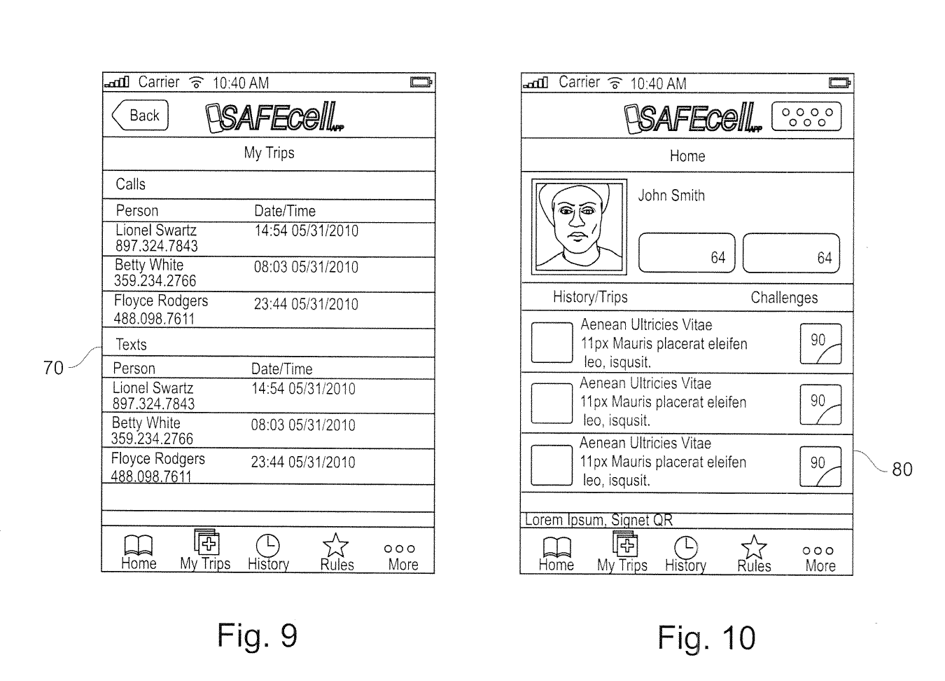

When the SafeCell application is enabled, any time vehicle is moving more than 4 miles per hour, the application disables text message, email, and telephone call functionality, responding to incoming communications with an automated message (or for example, providing a status of “X” via Facebook or Twitter) to let those others know that the user is temporarily unavailable because in transit. The SafeCell application logs text messages, email, and calls that were missed when disabled due to transit, as illustrated in FIG. 9. Once the SafeCell application has determined that motion has ceased, text messaging, email, and telephone functions are automatically re-enabled. In this “in transit” restricted-use mode, the SafeCell application includes an emergency override capability for 911 and up to three other emergency contact numbers, such as parents, employer, etc. A passenger-use override capability may also be included.

The SafeCell application logs the user's GPS location, speed, altitude, and heading. The SafeCell application can be enabled to provide other safety information prior to the user entering a predefined area in which protocols have been implemented that require specific safety equipment, standards, processes, prohibitions or other forms of pre-defined guidelines. In the event the user is entering into such an area, the SafeCell application provides the user with an automated message (for example, “Breathing Equipment Required From This Point On”) based on a database that stores geo-specific safety information.

According to a default operation setting, the restricted “in transit” mode, which restricts text message, email, and telephone call functionality when traveling at speed, may be suspended at any time by the mobile device user. However, the ability to suspend the restricted “in transit” mode may be limited due to parental settings, if desired. The SafeCell application logs when and where its restricted “in transit” mode is suspended, the particular cell phone usage that occurs during these periods, such as whether text messaging or voice telephone calls are made, what speeds and accelerations occurred during the period, and what legal restrictions were in place at the time. These parameters are logged to a web based account hosted on a SafeCell server computer, which can be accessed and reviewed by parents and employers, for example. Such web based account may include a customized landing page for the users, if desired. Additionally, for enterprise customers, reports may be available for download in excel or Adobe Acrobat file format for review and auditing of employees' adherence to the company's cell policies.

Based on the cell phone usage patterns developed during a user's trips, for example, whether or not text messaging is used while the phone is in motion or whether the mobile device is used in a “no cell phone” school zone, the system and method according to the preferred embodiment includes a web-based rewards and tracking system, in which points are accumulated by the user for rewarding safe behaviors. Likewise, points may be deducted from a user's point balance for unsafe mobile device usage (such as suspending the SafeCell application in order to receive or place a call). The reward points may be redeemed by the user in a variety of ways, such as in gift cards, vouchers, and the like. Reward points may also be used to promote gaming play between multiple subscribers to the SafeCell application, in which users can compete against one another to win prizes.

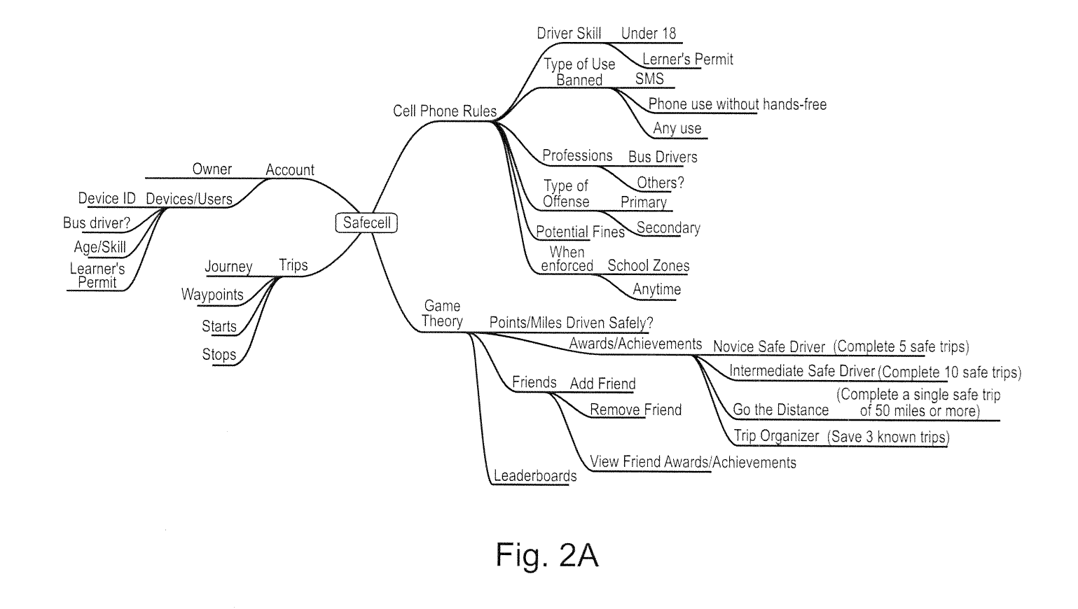

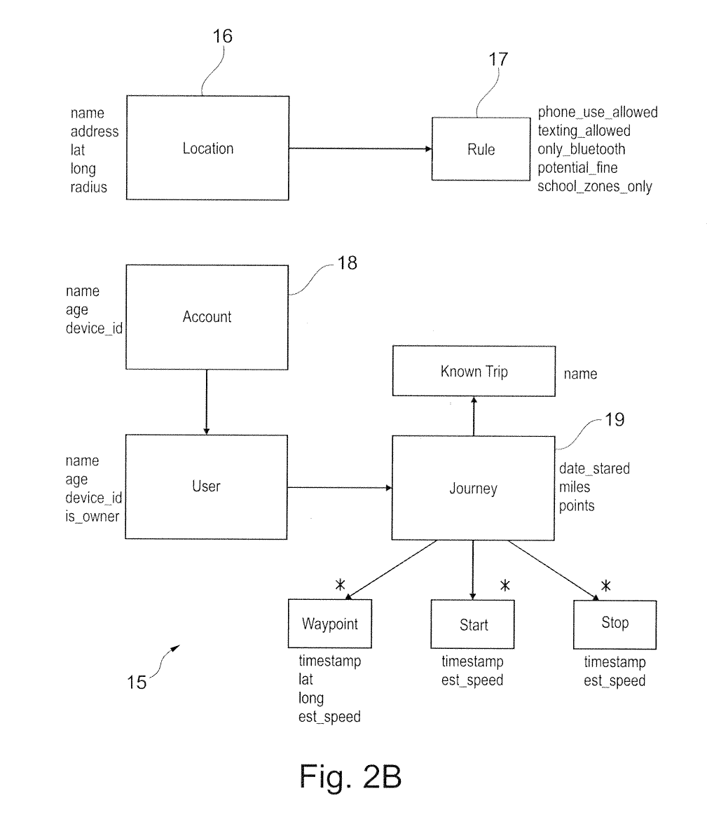

FIG. 2A is a high-level logic flow schematic according to a preferred embodiment of the invention, showing four distinct branches of logic account logic, trip logic, cell phone rule logic, and game theory logic that are provided to a SafeCell application client based on information supplied by the user. The distinct structure and functioning of each branch of logic is detailed below.

FIG. 2B is a block diagram illustrating a domain or data model of database 15. Location data for all schools, for example, is cataloged at block 16. Federal, state, county and local cell phone restrictions and prohibitions, if any, in the form of statutes, regulations, or ordinances are cataloged at block 17. Together, this data is processed by server computer 14 so that applicable cell phone restrictions are pushed to all mobile device clients 12 based on their individual locations in real time. Subscriber account information is stored at block 18, and each user's trip details is stored at block 19.

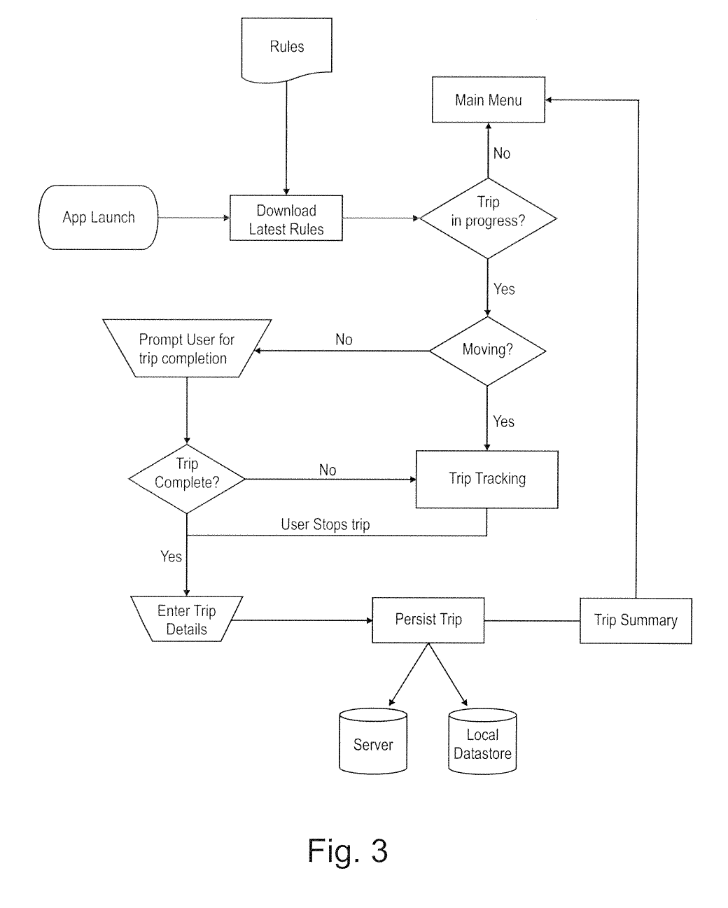

FIG. 3 is a block level flow chart outlining a preferred implementation of the trip logic branch of FIG. 2A wherein the movements of mobile device client 12 are tracked Its operation is illustrated as follows: A user enters vehicle and launches the SafeCell application to start a new trip, or the SafeCell application starts automatically once the application determines that the device is moving at more than 4 miles per hour. The car starts in motion, meanwhile the mobile device client 12 collects data pertaining to accelerometer and GPS activity, current location, and time. The data is used to describe a summary of the trip for later review. Specifically, the SafeCell application tracks the following data during a trip: Current location (based on GPS or Assisted GPS), estimated speed (based on GPS or Assisted GPS averaged over time), date, time, distance traveled, latitude, longitude, and interruptions. Interruptions may be caused by a number of activities, most notably incoming phone calls and text messages. The user may quit the application. The user may also suspend the SafeCell application to use the phone. When the SafeCell application is resumed, it continues tracking the trip.

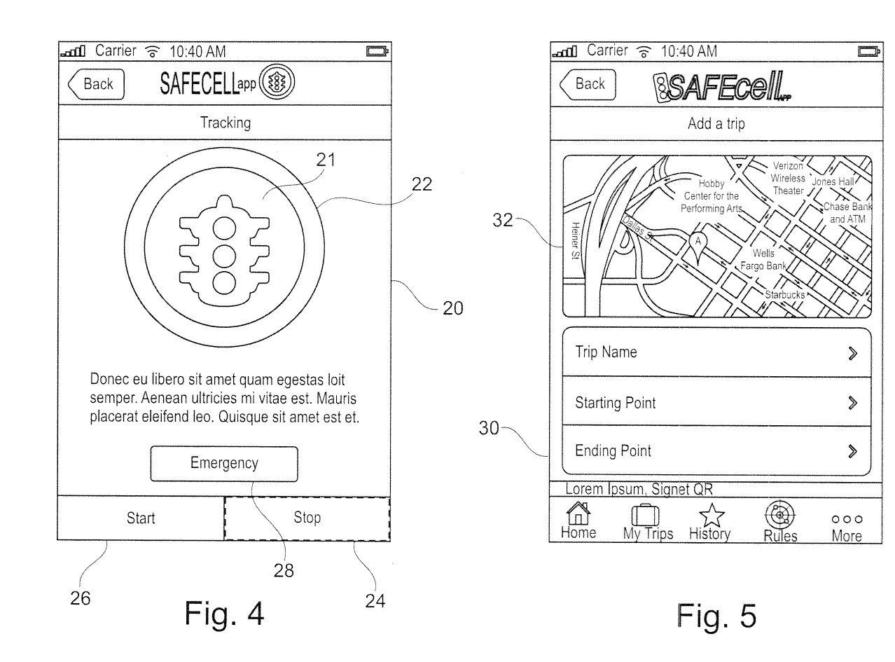

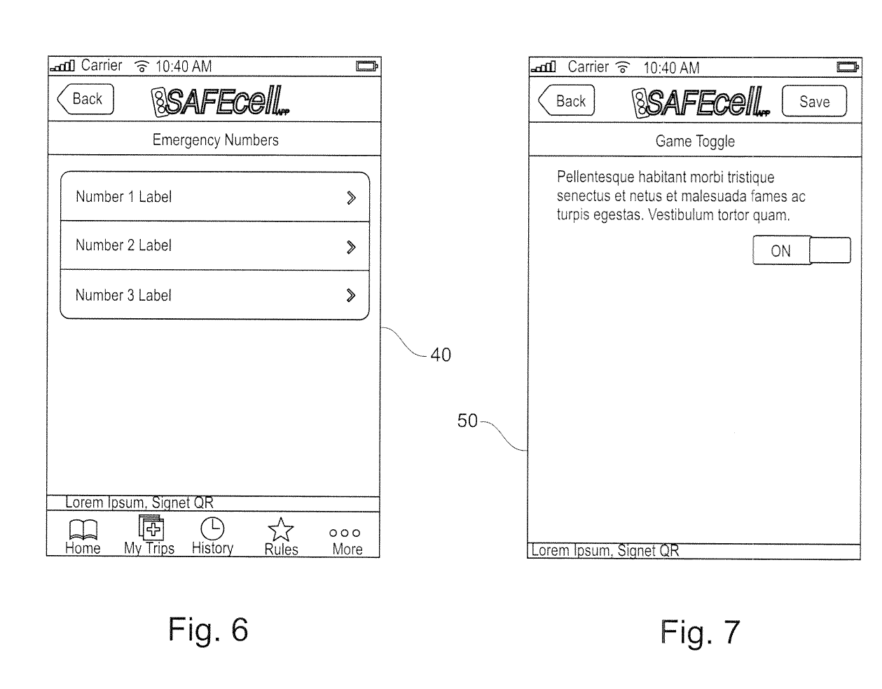

A tracking screen 20, such as that illustrated in FIG. 4, is visible during a trip. This screen serves as a visual reminder to not use the phone for SMS texting, email, or other activities such as entering a school zone. Additionally, the screen may provide prompts or subtle hints to the user that their current location has strict traffic laws around cell phone usage. For example, tracking screen 20 includes icons 21, 22 that represent the applicable cellular law(s) that are in place based on their real-time GPS location. These icons may include a school house icon for either being within 900 feet of a school or if there is a specific law for using a cellular device in a school zone, a text messaging bubble icon indicating there is a cellular law in place that prohibits texting, and/or a cell phone icon indicating that there is a cellular law in place that prohibits the use of a mobile device. Each of these icons are in a gray state unless the SafeCell application identifies that there is an applicable law in place for the users immediate GPS location. The icons turn red when a cell phone law or ordinance applies. Each change in appearance will be accompanied by an audible prompt of the corresponding law or ordinance indicating that there is a cell phone law in place. The user has the freedom to acknowledge the cell phone restriction notification and disable the texting function, for example, or to discard or disregard the prompt.

Buttons 24, 26 to suspend and resume the SafeCell application are provided, and an Emergency button 28 to allow emergency calls is provided. Pressing Emergency Button 28 opens Emergency Screen 40, from which 911 or other preprogrammed numbers may be quickly dialed by a single selection.

FIG. 5 illustrates an additional tracking screen 30, which may be used as a source of navigation information while driving, to plan a trip, or to save a trip after it has been completed, as described below. The navigation information by optionally be imported from a separate software application. Navigation screen 30 preferably includes a moving map 32, and areas of cell phone restriction are indicated as colored shading within map 32.

The SafeCell application incorporates a gaming aspect as a method of incentivizing drivers to utilize the application. This gaming aspect provides a user with a way to accrue points by using the application and not texting or using their cell phone in locations where cell phone use is prohibited by state or local laws. The SafeCell application provides users with various metrics on the levels that they have obtained. Once users have achieved predefined point levels, they have the ability to redeem their points for gift cards or similar rewards. The gaming mode can be toggled on and off in a Game Toggle Screen 50 as illustrated in FIG. 7.

At the end of the trip, if the game elements are enabled, the user is prompted by mobile device client 12 to name the trip (see FIG. 5) and to post it for scoring. The trip is saved to the device and uploaded to the server computer 14. Users earn points for long and/or repeated trips on which they safely leave the SafeCell application running the entire time. Interruptions to the SafeCell application reduce points.

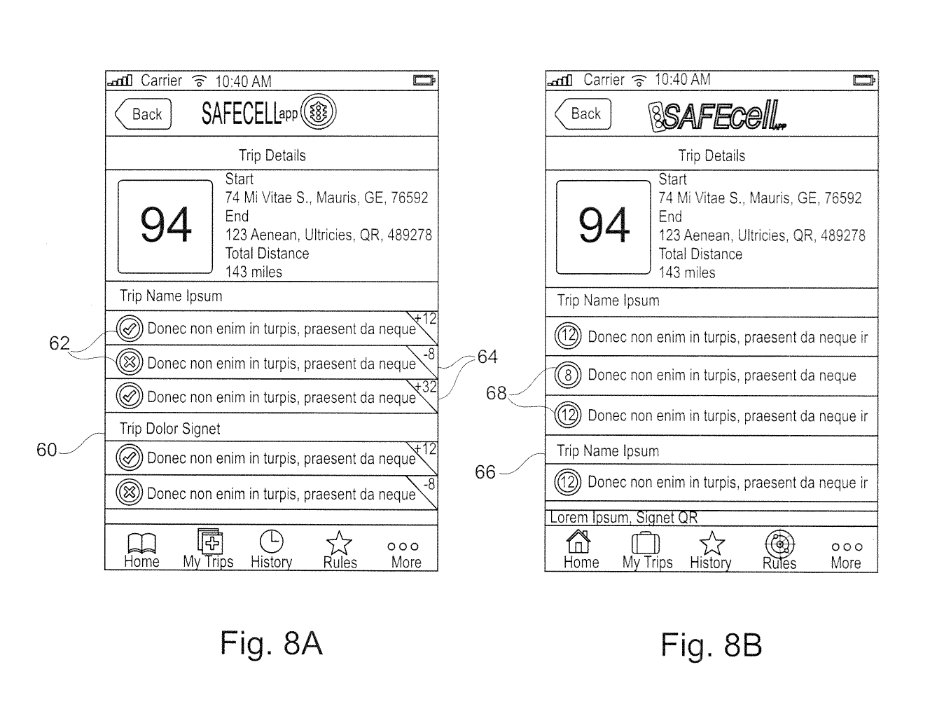

FIG. 8A is a view of a mobile device client recent trips screen 60, showing information for most recent trips, including start and end points and the gaming points earned. Status icons 62 indicating adherence or lack of adherence to applicable cell phone laws and gaming point indicia 64 that display gaming point rewarded or deducted for those trips are displayed. FIG. 8B is an alternative recent trips screen 66 in which the cell phone rules adherence and gaming points are displayed combined color coordinated indicia 68. For example, the number of points awarded may be displayed with a green background, and the number of points forfeited may be displayed with a red background. Recent trips screens 60 and 66 may also provide a brief explanation as to why points were awarded or deducted. FIG. 9 illustrates an optional trips history screen 70 in which interruptions or missed calls and texts during a particular trip are displayed.

FIG. 10 illustrates a user's home page screen 80. Screen 80 shows the user's last three trips and the score associated with each one of them. Screen 80 also shows the player's overall score utilizing the SafeCell application.

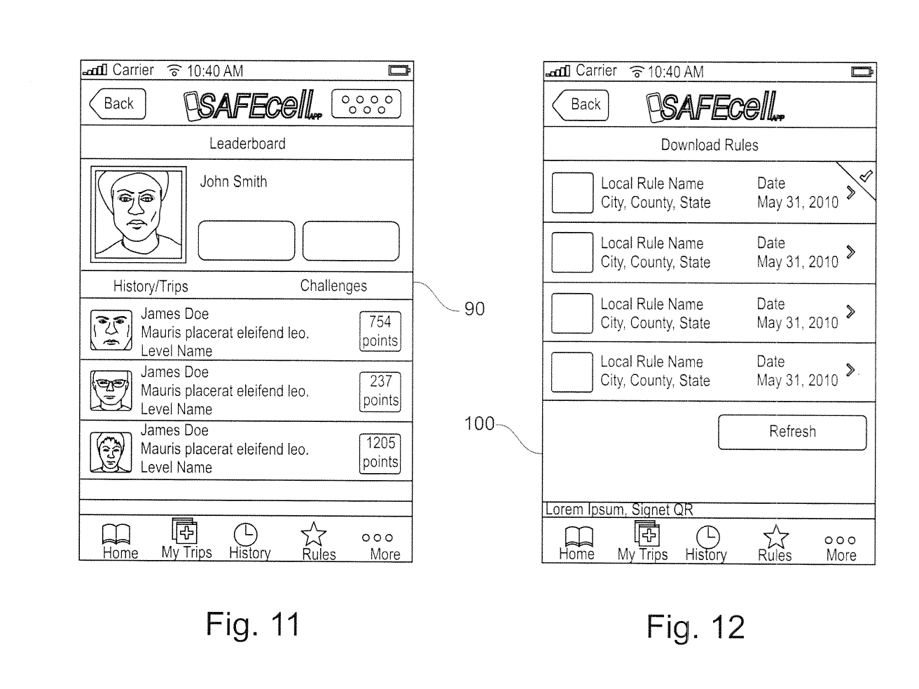

FIG. 11 illustrates a leader board screen 90 of the SafeCell application. Server computer 14 (FIG. 1) pushes leader board information, including the identity of SafeCell application subscribers having accrued the most points, to various mobile device clients 12. Various categories of competition, including categories that restrict contestants based on peer group (for example, age, sex or geography, such as students belonging to a particular school), business unit or division may be used to incentivize participation in the gaming and promote safe mobile device usage habits.

Cell phone usage rules vary by federal, state, county, city, and even within a municipality. Server computer 14 will select and download applicable rules for a user's current location, presenting the rules it in an easy-to-read format. These applicable rules are updated in real time as the user travels. For example, the SafeCell application may determine if a mobile device client 12 is located within a known school zone by utilizing a Google Maps application with overlay technology. However, other suitable Geographic Information System (GIS) technology and methods may be used as appropriate. FIG. 12 illustrates a mobile device client screen 100 in which cell phone rules for particular areas can be selected and manually downloaded for viewing by the user, if desired.

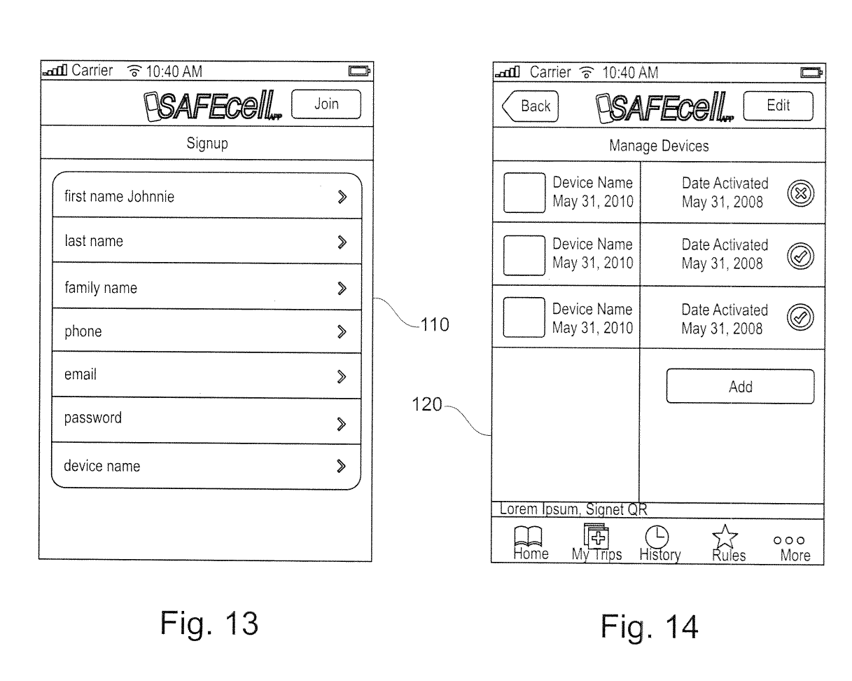

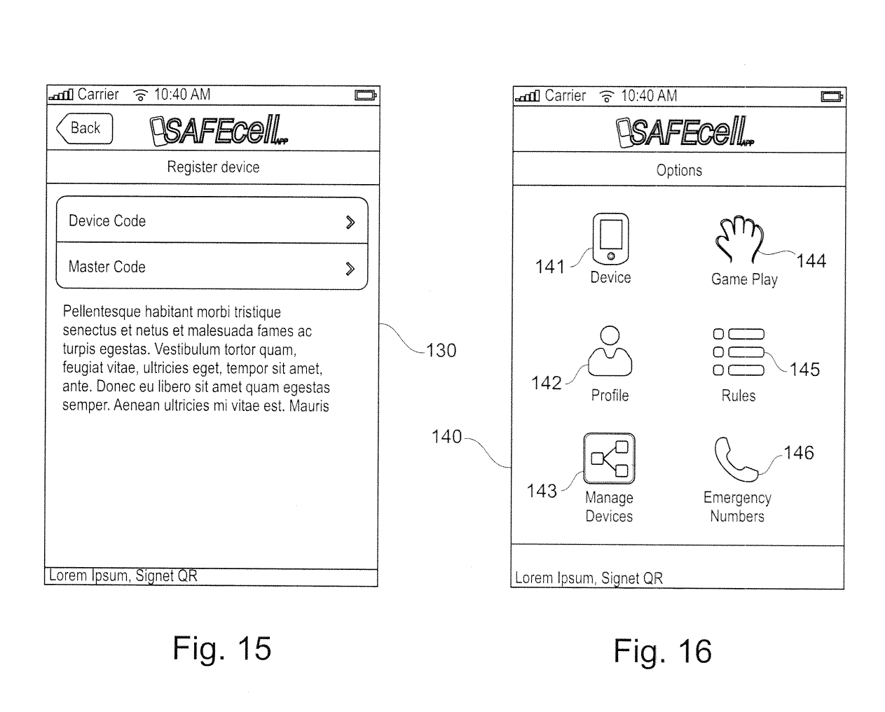

The SafeCell system provides for parental or company controls, including the ability for parents or companies to set default rules for the application. For example, parents may disable the user's ability to suspend, or interrupt, operation of the SafeCell application in order to place or receive calls, emails or text messages when in motion. Parents and companies have the ability to preload the application to new or existing phones, and application preferences have the ability to be password protected. Parents and companies have the ability to preload the application with specific times that certain features of the phone are functional. Parents and companies have the ability to preload the application with pre-defined geographical areas that certain features of the mobile device will function along with notification if the mobile device leaves the pre-defined geographical area(s). FIG. 13 illustrates a signup screen 110. Signup screen 110 appears after the SafeCell application has been successfully downloaded to a mobile device. The subscriber inputs appropriate information into each of the fields. FIG. 14 illustrates an account management screen 120, in which multiple devices can be associated with a family account, for example. FIG. 15 illustrates a password entry screen 130 that may be used in conjunction with parental or company control.

FIG. 16 illustrate an options screen 140 of the SafeCell application software. From options screen 140, the user can update device information by selecting the “Device” icon 141, input personal information for mobile device client 12 by selecting the “Profile” icon 142, manage devices from management screen 120 (FIG. 14) by selecting the “Manage Devices” icon 143, see earned game points and access the leader board screen 90 (FIG. 11) by selecting the “Game Play” icon 144, view applicable cell phone rules based on GPS location by selecting the “Rules” icon 145, and program emergency numbers by selecting the “Emergency Numbers” icon 146.

While the invention is described above with reference to a SafeCell mobile device client 12, the SafeCell application may alternatively be preloaded or downloaded directly to a vehicle's memory, hard drive and executed by an onboard computer system, such as an onboard navigation system, or by an aftermarket navigation system such as a TomTom or Garmin GPS system, for example within the scope of the invention. The SafeCell applications cellular laws at a federal, state, county, and city may be pushed directly to the above devices as additional content for other existing application or integrated into the devices via an application program interface.

The Abstract of the disclosure is written solely for providing the United States Patent and Trademark Office and the public at large with a way by which to determine quickly from a cursory reading the nature and gist of the technical disclosure, and it represents solely a preferred embodiment and is not indicative of the nature of the invention as a whole.

While some embodiments of the invention have been illustrated in detail, the invention is not limited to the embodiments shown; modifications and adaptations of the above embodiment may occur to those skilled in the art. Such modifications and adaptations are in the spirit and scope of the invention as set forth herein:

1. A method for incentivizing a user to form safe cell phone usage habits comprising the steps of:
receiving by a central server a geographic location of a mobile device user;
transmitting by said central server an applicable legal restriction on mobile device usage to a mobile device of said user based on said geographic location; and
providing points by said central server to said mobile device of said user based on said user complying with said applicable legal restriction.

2. A method of providing relevant safety information to a user of a mobile device comprising the steps of:
receiving by a central server a geographic location of said mobile device;
transmitting by said central server an applicable safety message based in said geographic location.
